(19) United States
(12) Patent Application Publication
(10) Pub. No.: US 2016/0357407 A1
(43) Pub. Date: Dec. 8, 2016

(54) Emotive Ballistics

(71) Applicant: Victorious, Inc., Santa Monica, CA (US)

(72) Inventors: Samuel Ernst Rogoway, Pacific Palisades, CA (US); Michael Todd, Santa Monica, CA (US); Anar Joshi, Venice, CA (US); Joshua Hinman, Los Angeles, CA (US); Matthew Steven Marzilli, Santa Monica, CA (US); Spencer Chen, Laguna Niguel, CA (US)

(21) Appl. No.: 15/173,641

(22) Filed: Jun. 4, 2016

Related U.S. Application Data
(60) Provisional application No. 62/171,207, filed on Jun. 4, 2015.

(51) Int. Cl. G06F 3/0484; G06F 3/0481; G06T 13/80

(52) U.S. Cl. CPC G06F 3/04842; G06T 13/80; G06F 3/04817

(57) ABSTRACT

Systems, methods and interfaces allow the user to add a range of expressive animations, animated tags, to specific temporal ranges or locations in media content. The method for providing expressive animations includes providing a user interface for selecting an animated tag to add to media content, the user interface presenting the media content, receiving a selection of the animated tag and an attribute of the media content, responsive to receiving the selection of the animated tag and the attribute of the media content, adding the animated tag to media content based upon the attribute, and providing the media content with the added animated tag for display.

### CROSS REFERENCE TO RELATED APPLICATIONS

The present application claims priority, under 35 U.S.C. §119(e), to U.S. Provisional Patent Application No. 62/171,207, filed Jun. 4, 2015 entitled “Emotive Ballistics,” which is incorporated herein by reference in its entirety.

### FIELD OF THE INVENTION

The present invention relates to augmenting media content with animation and tracking user interactions with media content. In particular, the present disclosure relates to providing animated tags for users to apply to the media content being presented at specific temporal ranges.

### BACKGROUND

In recent years, there has been widespread adoption and use of computers and smart phones for communication involving images and video. There are number of authors that are prolific in creating new content including text, images and video. These author often develop their own following of user that want but have no way to interact with each other. Historically, user interaction with such content has largely been limited to viewing or reading such content. The user has little interaction with others that have viewed the content or with the author.

The prior art has attempted to address this issue, but interaction with the content available on social networks, video sharing services or photo services continues to be very limited. Some of these services offer limited abilities to endorse an entire piece of content, provide comments about a particular piece of content or in some cases re-transmit or share the content with others. However, these limited operations are typically in a different domain that the content. For example, for videos and images, there is little ability to interact with or add to the content then provide that modified content with others. This is particularly a problem in the video domain where a particular item of content may be an hour long, but the portions that the user wants to call out, interact with or engage with others can be limited to minutes or even seconds.

### SUMMARY

This invention relates to systems and methods for creating, sending, receiving, or displaying media content that has been augmented with a range of expressive animations, animated tags with different amounts of expressiveness, to specific temporal ranges of the media content. According to one aspect of the subject matter described in this disclosure, a system includes a processor, and a memory storing instructions that, when executed, cause the system to perform operations comprising: providing a user interface for selecting an animated tag to add to media content, the user interface presenting the media content, receiving a selection of the animated tag and an attribute of the media content, responsive to receiving the selection of the animated tag and the attribute of the media content, adding the animated tag to media content based upon the attribute, and providing the media content with the added animated tag for display.

In general, another aspect of the subject matter described in this disclosure includes a method that includes providing a user interface for selecting an animated tag to add to media content, the user interface presenting the media content, receiving a selection of the animated tag and an attribute of the media content, responsive to receiving the selection of the animated tag and the attribute of the media content, adding the animated tag to media content based upon the attribute, and providing the media content with the added animated tag for display.

Other implementations of one or more of these aspects include corresponding systems, apparatus, and computer programs, configured to perform the actions of the methods, encoded on computer storage devices.

These and other implementations may each optionally include one or more of the following features. For instance, the user interface may include a plurality of icons each icon corresponding to a different animated tag. Another feature may be that the media content is video, the attribute of the media content is a temporal range within the video, and the animated tag is added to the video within the temporal range. Yet another feature may be that the media content is an image, the attribute of the media content is a location in the image, and the animated tag is added to the image to appear near the location in the image. Additionally, the selection may be a swipe gesture beginning at an icon in the user interface, the icon representing the animated tag, the swipe gesture toward the media content, and wherein the icon is further animated to appear as being thrown from an icon bar including the icon onto a window displaying the media content. Still further, the animated tag may be represented in the user interface with a locked icon and is not selectable until an action unlocks the animated tag making it usable. Finally, the method may further comprise disabling selection of the animated tag in the user interface for a predetermined amount of time.

It should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a high-level block diagram illustrating an example system for enabling and tracking user interactions with media content according to the present disclosure.

FIG. 2 is a block diagram illustrating an example system including an emotive ballistics application of the present disclosure.

FIG. 3 is a flow chart of an example method for enabling user interactions with media content.

FIG. 4 is a flow chart of an example method for controlling the use of emotive ballistics based on payment or merit based systems.

FIG. 5 is a flow chart of an example method for limiting the use of emotive ballistics.

FIG. 6 is a flow chart of an example method for logging emotive ballistics use and providing analytics based on the logged results.

FIG. 7 is a flow chart of an example method for modifying future display of media content based on a log of past user interactions with the media content.

FIG. 8 is a flow chart of an example method for determining emotive ballistics settings based on user and content provider attributes.

FIG. 9 is a flow chart of an example method for emotive ballistics management by a content provider.

FIG. 10 is a graphic representation of an example media player application including an emotive ballistics bar.

FIG. 11 is a graphic representation of an example media player application with a superimposed emotive ballistic.

FIG. 12 is a graphic representation of an example media player application with a superimposed emotive ballistic.

FIGS. 13A-13D are graphic representations of a pay screen for purchasing an emotive ballistic.

FIG. 14 is a graphic representation of an example interface for managing emotive ballistics available for users while viewing media content.

FIG. 15 is a graphic representation of an example interface for displaying emotive ballistics analytics.

FIG. 16 is a graphic representation of an example bar chart showing emotive ballistic use for a media content over time.

FIG. 17 is a graphic representation of an example heat map showing emotive ballistic location on media content at a particular time.

FIG. 18 is a graphic representation of an example media player application including a user interface for emotive ballistics according to another implementation.

FIG. 19 is a graphic representation of an example media player application including a user interface showing a sent or thrown emotive ballistic.

FIGS. 20A-20B are graphic representations of an example media player application a user interface showing a locked and unlocked emotive ballistic.

FIG. 21 is a graphic representation of an example media player application including a user interface showing emotive ballistics for a locked level.

FIG. 22 is a graphic representation of an example media player application including a user interface showing an emotive ballistics with a countdown timer before the emotive ballistics is selectable.

FIG. 23 is a graphic representation of an example media player application including one implementation of the user interface that includes a display of when and how many emotive ballistics are being sent by others.

### DETAILED DESCRIPTION

Systems, methods and interfaces for enabling the addition of a range of expressive animations, animated tags or emotive ballistics, to specific temporal ranges of media content are described below. The systems, methods and interfaces also provide tracking user interactions with media content including time and frequency of use of emotive ballistics. While the systems and methods of the present disclosure are described in the context of a system having a single server and client device, it should be understood that the systems, methods and interfaces can be applied to other systems. The systems and methods described below. Further, the terms animated tags or emotive ballistics are used interchangeably throughout this application to refer to the supplemental animations or images added to media content at different times and locations.

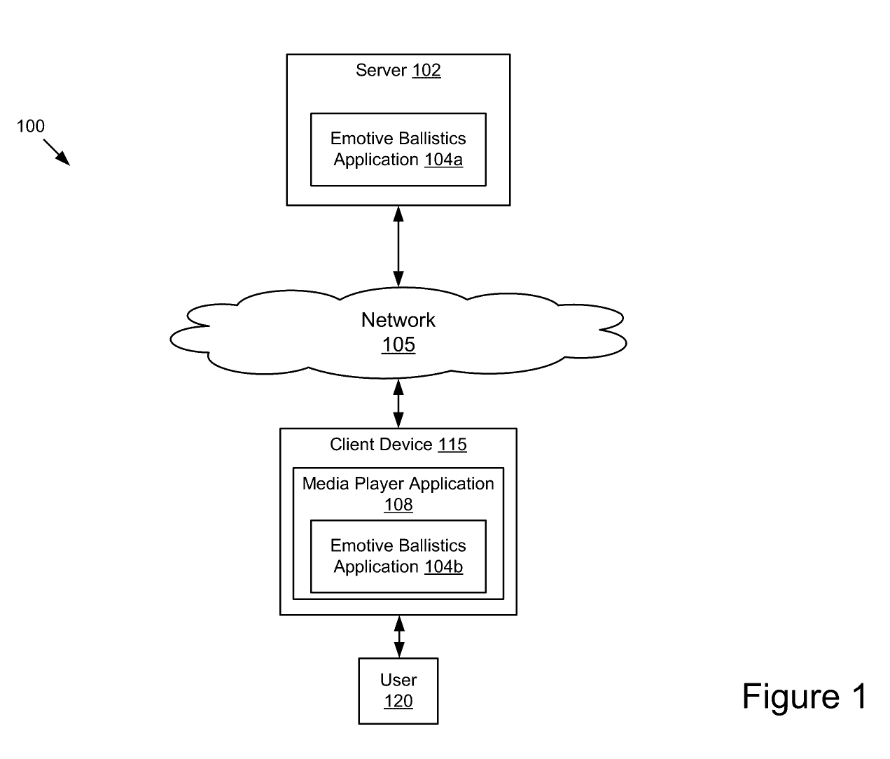

FIG. 1 is a high-level block diagram illustrating an example system for enabling and tracking user interactions with media content according to the present disclosure. The system 100 includes a client device 115 that is accessed by user 120, a server 102, and network 105. The client device 115 may include a media player application 108 and an emotive ballistics application 104b. The server 102 and client device 115 cooperate to implement an emotive ballistics application 104 (depicted in the example of FIG. 1 as emotive ballistics applications 104a and 104b). In some embodiments, a client device 115 may be configured to run all or part of the emotive ballistics application 104. For example, in one embodiment, the emotive ballistics application 104b acts as a thin-client application with some functionality executed on the client device 115 and additional functionality executed on the recognition server 102 by emotive ballistics application 104a.

Server 102 may be, for example, a media server. In one embodiment, server 102 may be a general purpose computer, including one or more processors and memory, running software that serves media content to client device 115 over the network 105. In another embodiment, server 102 may be a dedicated appliance, including one or more processors and memory, specifically designed for serving media content to client device 115 over the network 105.

The client device 115 can be any computing device including one or more memory and one or more processors, for example, a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of accessing a network. In some implementations, the system 100 includes a combination of different types of client devices 115. For example, a combination of a personal computer and a mobile phone. It should be understood that the techniques described herein may operate on different models other than a client-server architecture.

The client device, as illustrated in the example of FIG. 1, may include a media player application 108 configured to receive and render media content from the server 102. The media player application may include, for example, a web browser based application or a native program/application. The media player application may include an emotive ballistics application 104b which provides users an interface to apply animated tags, or “emotive ballistics”, to the media being presented by the media player. Animated tags are code and graphics that when executed cause the display of an image or animation to appear overlaid on the content at prescribed locations or prescribed times. The prescribed location or time period is determined based what media content is being displayed in the window of the user interface when the icon corresponding to the animated tag is selected and “thrown” onto the media content. For example, as described in more detail herein, the emotive ballistics application 104b may provide an interface that the user 120 interacts with to launch the emotive ballistics onto the media content which is shown with additional animation.

The network 105 can be a conventional type, wired or wireless, and may have numerous different configurations including a star configuration, token ring configuration, or other configurations. Furthermore, the network 105 may include a local area network (LAN), a wide area network (WAN) (e.g., the internet), and/or other interconnected data paths across which multiple devices (e.g., server 10, client device 115, etc.) may communicate. In some embodiments, the network 105 may be a peer-to-peer network. The network 105 may also be coupled with or include portions of a telecommunications network for sending data using a variety of different communication protocols. In some embodiments, the network 105 may include Bluetooth (or Bluetooth low energy) communication networks or a cellular communications network for sending and receiving data including via short messaging service (SMS), multimedia messaging service (MMS), hypertext transfer protocol (HTTP), direct data connection, WAP, email, etc. Although the example of FIG. 1 illustrates one network 105 coupled to server 102 and client device 115, in practice one or more networks 105 can connect these entities.

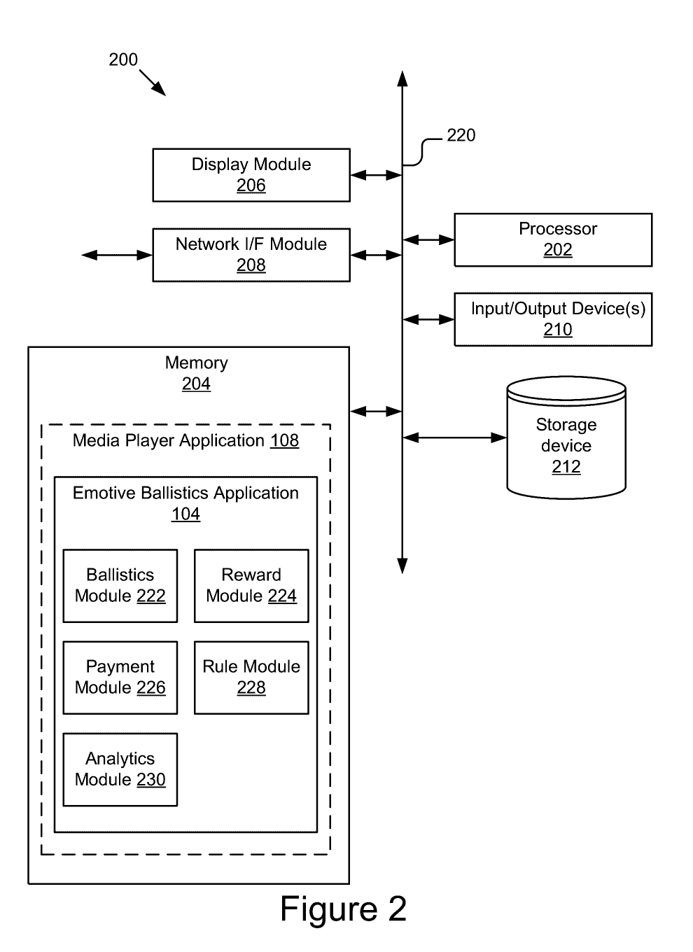

FIG. 2 is a block diagram illustrating an example system 200 including an emotive ballistics application 104 of the present disclosure. The system 200 may be, for example, a server 102 or a client device 115 as illustrated in the example of FIG. 1. In the example of FIG. 2, the system 200 includes a processor 202, a memory 204, a display module 206, a network interface (I/F) module 208, input output device(s) 210, and a storage device 212. The components of the system 200 are communicatively coupled to a bus or software communication mechanism 220 for communication with each other.

The processor 202 may include an arithmetic logic unit, a microprocessor, a general purpose controller or some other processor array to perform computations and provide electronic display signals to a display device. In some implementations, the processor 202 is a hardware processor having one or more processing cores. The processor 202 is coupled to the bus 220 for communication with the other components of the system 200. Processor 202 processes data signals and may include various computing architectures including a complex instruction set computer (CISC) architecture, a reduced instruction set computer (RISC) architecture, or an architecture implementing a combination of instruction sets. Although only a single processor is shown in the example of FIG. 2, multiple processors and/or processing cores may be included. It should be understood that other processor configurations are possible.

The memory 204 stores instructions and/or data that may be executed by the processor 202. In the illustrated implementation, the memory 204 includes an emotive ballistics application 104 and optionally a media player application 108. The memory 204 is coupled to the bus 220 for communication with the other components of the system 200. The instructions and/or data stored in the memory 204 may include code for performing any and/or all of the techniques described herein. The memory 204 may be, for example, non-transitory memory such as a dynamic random access memory (DRAM) device, a static random access memory (SRAM) device, flash memory or some other memory devices.

The emotive ballistics application 104, stored on memory 204 and executed by processor 202, may include various modules configured to implement the techniques disclosed herein. For example, the emotive ballistics application 104 includes a ballistics module 222, a reward module 224, a payment module 226, a rule module 228, and an analytics module 230. While the emotive ballistics application 104 in the example of FIG. 2 includes specific modules described to perform specific functions, it should be understood that the functionality described herein may be divided among fewer, more, or different modules.

The ballistics module 222 can be software or routines for generating and presenting an emotive ballistics interface for users and content providers. In one embodiment, the ballistics module 222 may be configured to present the emotive ballistics interface to the user 120, detect an input from the user, and display a selected emotive ballistic on the media content. In further embodiments, the ballistics module 222 may be configured to provide an interface to content providers to allow the content provider to manage and/or create emotive ballistics that are available for a user.

The reward module 224 can be software or routines for providing rewards to users for launching emotive ballistics on media content. In one embodiment, the reward module 224 may record statistics of emotive ballistics used by user 120. In some embodiments, the rewards module 224 may provide rewards to users (e.g., exclusive emotive ballistics, meet and greets with content providers, merchandise, etc.) if a user exceeds a threshold level of emotive ballistic use. The threshold may be set, for example, on a media content item basis, a content provider basis, or the like.

The payment module 226 can be software or routines for generating a payment interface for accessing emotive ballistics. In some embodiments, the emotive ballistics application 104 may provide a number of free emotive ballistics to users. Additional emotive ballistics may be provided to users for purchase. The payment module 226 may provide a payment interface and keep a record of a user's purchased emotive ballistics. In some embodiments, the payment module 226 may interface with a device operating system to use third party payment systems (e.g., in-app purchase or the like).

The rule module 228 can be software or routines for limiting a user's access to emotive ballistics. In some embodiments, to generate scarcity and demand for emotive ballistics, the rule module 228 may track the number of emotive ballistics a user has launched and display an indication of how many emotive ballistics are remaining for the user to launch. In another embodiment, the rule module may determine a user's location and/or the location of the content provider and determine which set of emotive ballistics should be made available to the user, how much they should be purchased for, and the like.

The analytics module 230 can be software or code for analyzing emotive ballistic use and presenting statistics, graphs, charts, and the like to content providers. The analytics module 230 can track, for example, the number of emotive ballistics launched at a particular media content item, a timestamp for the emotive ballistic, a location within the media content item, and the like. The analytics module 230 may present the statistics to the content provider in various formats, for example, charts, timelines, heat maps, etc. as discussed herein.

The display module 206 is a liquid crystal display (LCD), a plasma display, a light emitting diode display, an OLED (organic light-emitting diode) display, an electronic paper display, or any other similarly equipped display device, screen or monitor. The display module 206 represents any device equipped to display user interfaces, electronic images and data as described herein. In different embodiments, the display is binary (only two different values for pixels), monochrome (multiple shades of one color), or allows multiple colors and shades. The display module 206 is coupled to the software communication mechanism 220 to receive data and images for display. In some embodiments, the system 200 may have a touch sensor associated with the display 206 to provide a touchscreen display configured to receive touch inputs for enabling interaction with a graphical user interface presented on the display 206. Accordingly, embodiments described herein are not limited to any particular display technology.

The network interface module 208 is configured to connect the system 200 to a network, e.g., network 105. For example, network interface module 208 may enable communication through one or more of the internet, cable networks, and wired networks. The network interface module 208 links the processor 202 to the network 105 that may in turn be coupled to other processing systems (e.g., server 102). The network interface module 208 also provides other conventional connections to the network 105 for distribution and/or retrieval of files and/or media content using standard network protocols such as TCP/IP, HTTP, HTTPS and SMTP as will be understood. In some implementations, the network interface module 208 includes a transceiver for sending and receiving signals using Wi-Fi, Bluetooth® or cellular communications for wireless communication.

The system 200 may further include one or more I/O devices 210. The I/O devices 210 may include speakers, a microphone, a camera, and various user controls (e.g., buttons, a joystick, a keyboard, a keypad, touchscreen, etc.), a haptic output device, and so forth.

The storage device 212 may be, for example, a non-transitory storage device such as a dynamic random access memory (DRAM) device, a static random access memory (SRAM) device, flash memory or some other memory device. In some implementations, the storage device also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

Software communication mechanism 220 may be an object bus (e.g., CORBA), direct socket communication (e.g., TCP/IP sockets) among software modules, remote procedure calls, UDP broadcasts and receipts, HTTP connections, function or procedure calls, etc. Further, any or all of the communication could be secure (SSH, HTTPS, etc.). The software communication mechanism 220 can be implemented on any underlying hardware, for example, a network, the Internet, a bus, a combination thereof, etc.

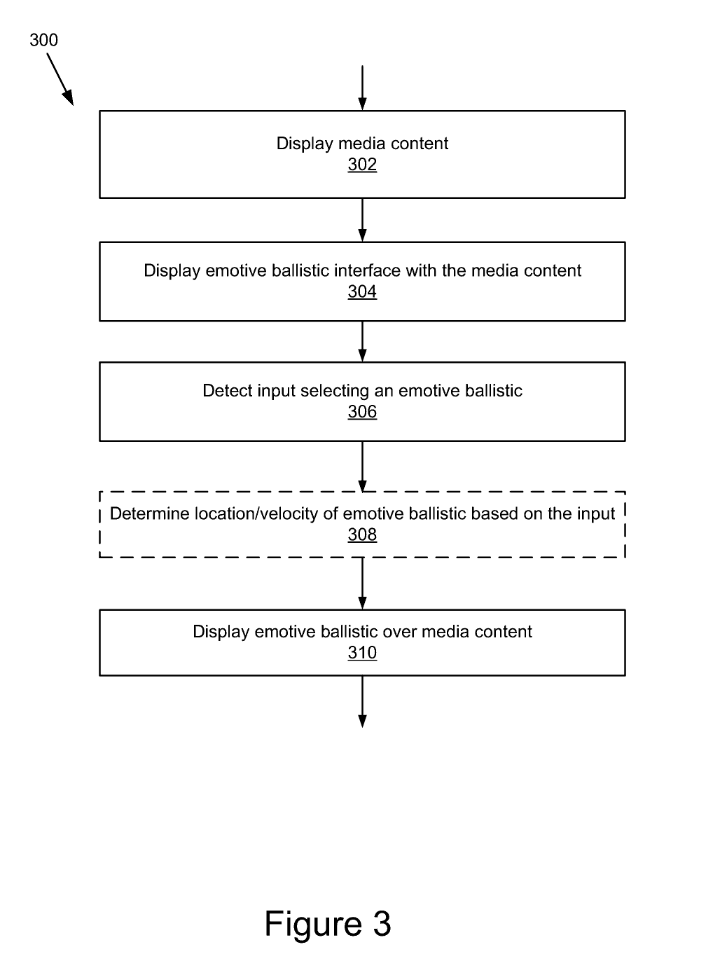

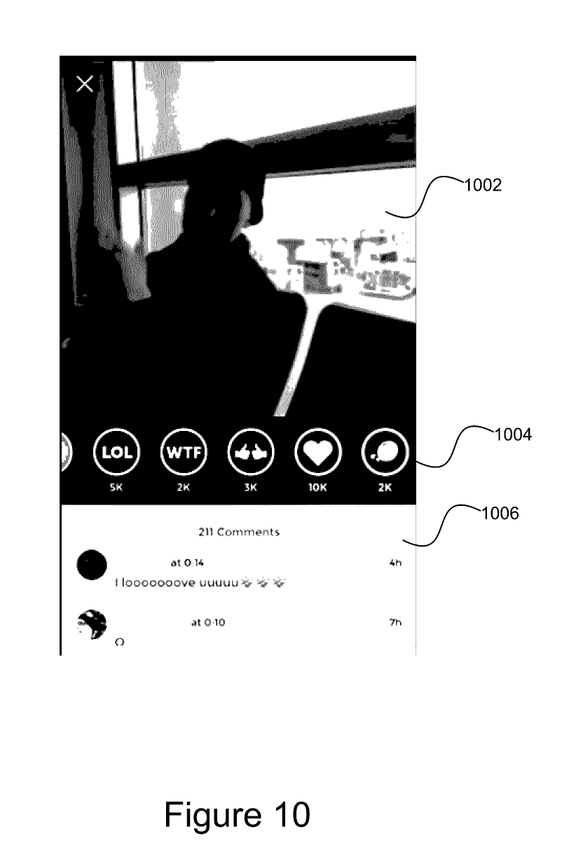

FIG. 3 is a flow chart of an example method 300 for enabling user interactions with media content. At 302, the media player 108 may display media content to a user. The ballistics module 222, at 304, may display the emotive ballistics interface in conjunction with the media player 108 displaying the media content. For example, the ballistics module 222 may present a toolbar, or the like, including the emotive ballistics available for use, purchase, or the like. FIG. 10 is a graphic representation of an example media player application including a user interface with a window 1002 for displaying media content 1002 and an icon bar 1004 for displaying one or more selectable icons representing or corresponding to animated tags. This is also referred to as an emotive ballistics bar 1004. Below the icon bar 1004 is a comments section 1006 displaying comments about the media content that other users have posted.

Returning to the example of FIG. 3, at 306, the ballistics module 222 detects an input from the user 120 selecting an emotive ballistic. In various embodiments, the input may be a click, a tap, or another gesture such as a swipe, etc. In some embodiments, the ballistics module 222 may determine, at 308, a location and/or velocity to launch the emotive ballistic based on the input. For example, the ballistics module 222 may infer a direction and speed to launch the emotive ballistic based on the speed and direction of a user's swipe on the display. Similarly, a user may tap and drag an emotive ballistic from the bar to a location in the media content frame and the ballistics module 222 launches the emotive ballistic at that location.

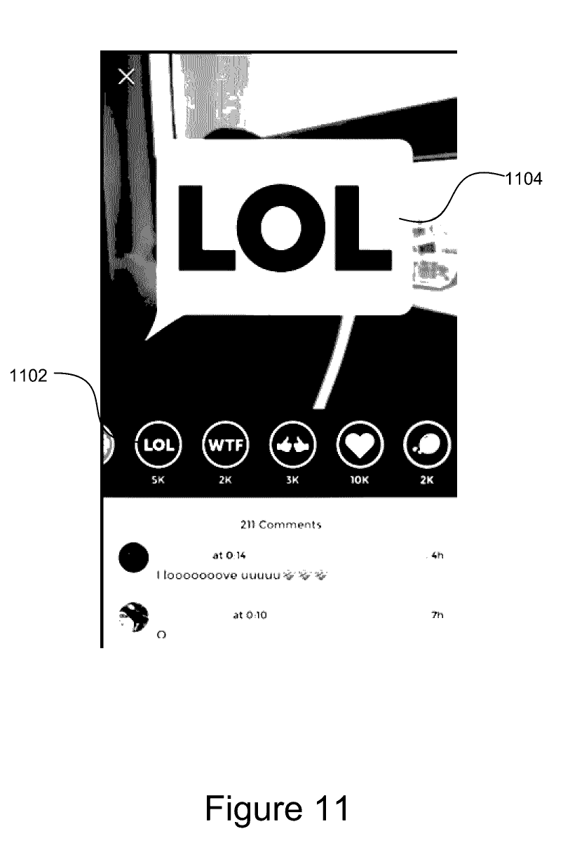

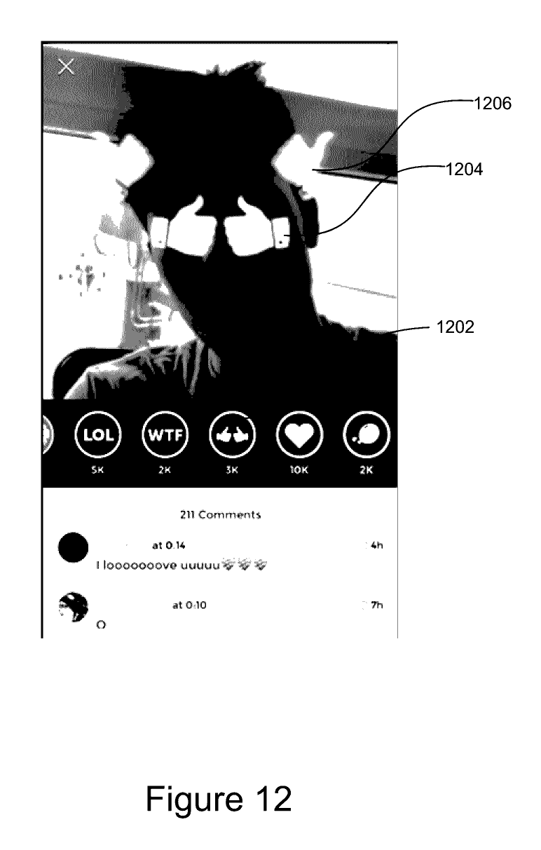

At 310, the ballistics module 222 may display the emotive ballistic over the media content. FIG. 11 is a graphic representation of an example media player application with a superimposed emotive ballistic 1104. In response to the user input selecting the “LOL” symbol 1102 from the emotive ballistics bar, the emotive ballistic 1104 is displayed over the media content. In various embodiments, the emotive ballistic 1104 may be an animation, a “sticker”, etc. FIG. 12 is a graphic representation of another example media player application with a superimposed emotive ballistic. In response to the user input selecting the “thumbs-up” ballistic 1202 from the emotive ballistics bar, the ballistics module 222 displays an animated thumbs-up ballistic. In the example of FIG. 12, the animation of the emotive ballistic may be seen as the thumbs up starts at position 1204 and fades to position 1206.

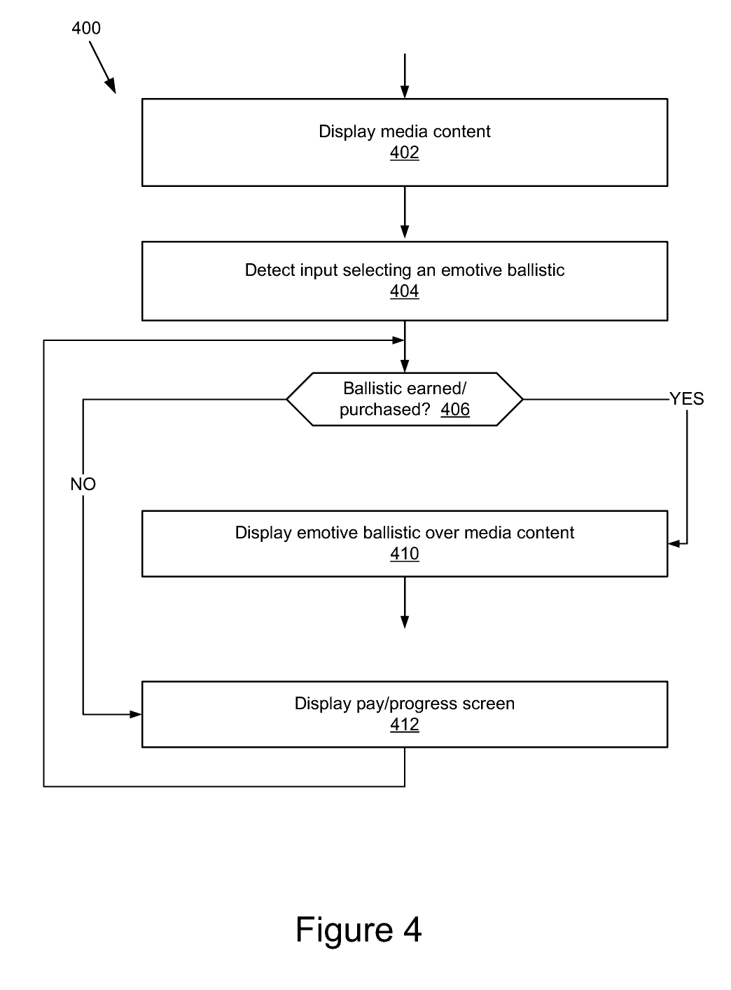

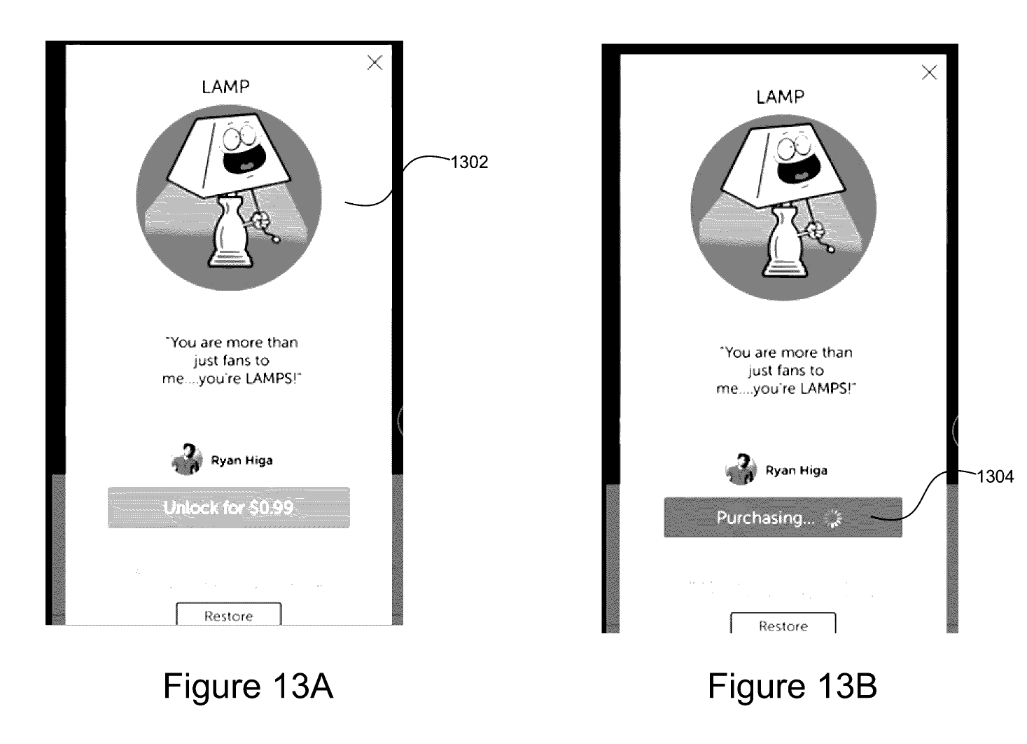

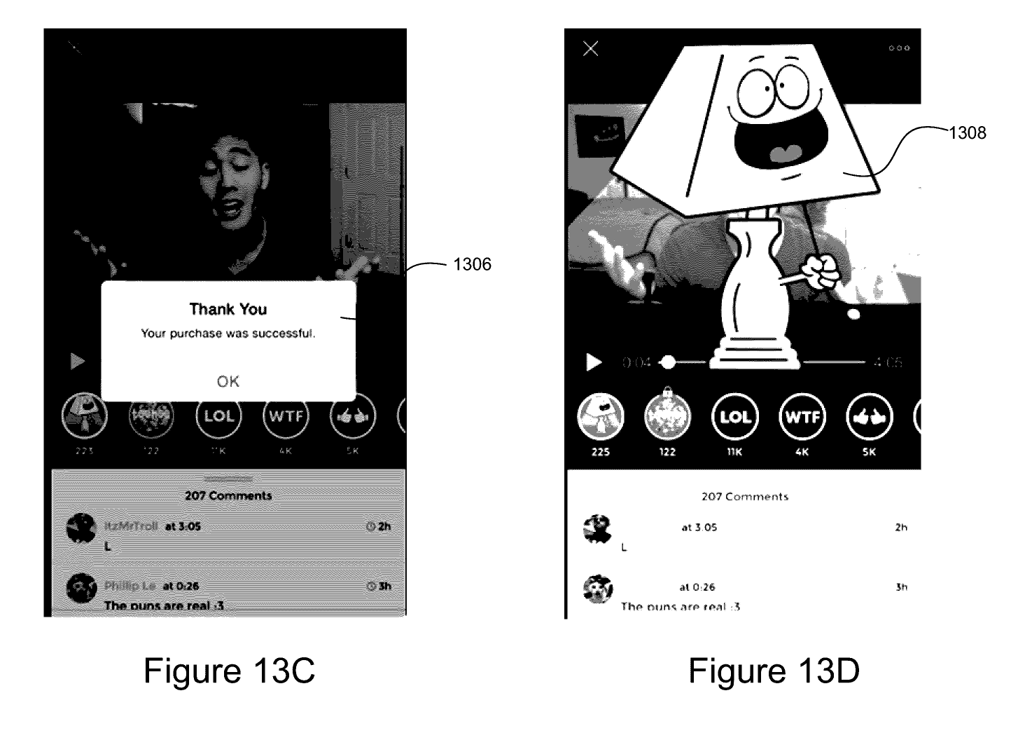

FIG. 4 is a flow chart of an example method 400 for controlling the use of emotive ballistics based on payment or merit based systems. At 402, the media player 108 may display media content to a user. The ballistics module 222, at 404, detects an input selecting an emotive ballistic. In one embodiment, at 406, the payment module 226 determines whether the emotive ballistic has been purchased and if yes, the ballistics module 222 displays, at 410, the emotive ballistic over the media content. In another embodiment, at 406, the reward module 224 determines whether the emotive ballistic has been earned by the user. If the reward module 224 determines that the emotive ballistic has been earned, the ballistics module 222, at 410, displays the emotive ballistic over the media content. If at, 406, the payment module 226 determines that the emotive ballistic has not been purchased, at 412, the payment module 226 displays a pay screen. FIGS. 13A-D are graphic representations of a pay screen 1302 for purchasing an emotive ballistic. In response to detecting an input to purchase the emotive ballistic 1304, the payment module 226 may display a purchase confirmation 1306. The ballistics module 222 may then display the emotive ballistic 1308 over the media content. Returning to the example of FIG. 4, if at 406, the reward module 224 determines that the emotive ballistic has not been earned, the reward module 224 may display a progress screen to the user depicting progress toward unlocking the emotive ballistic.

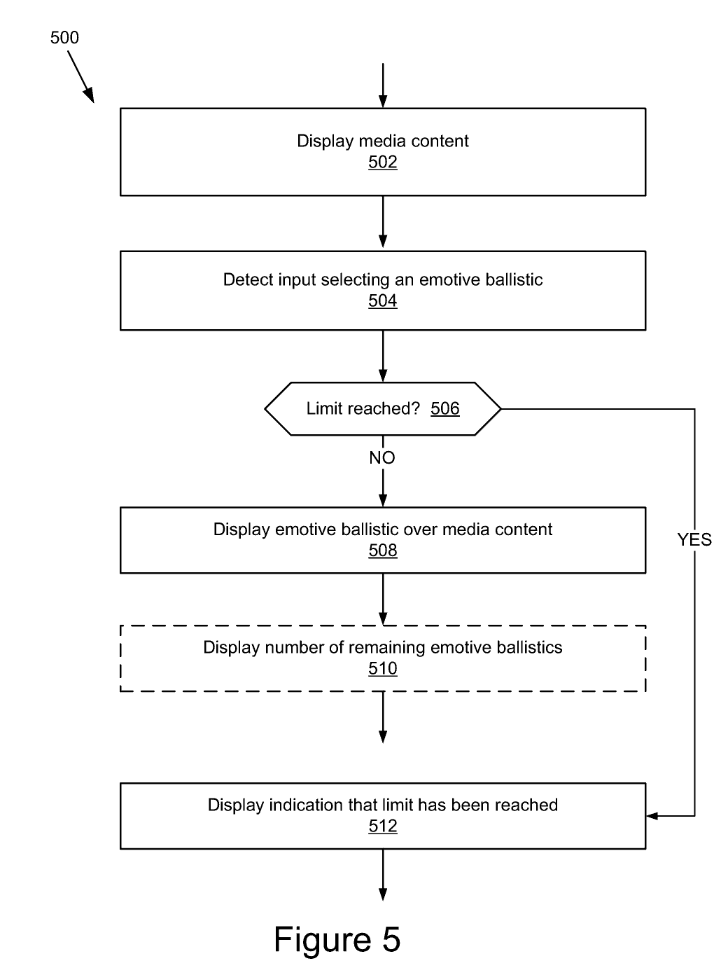

FIG. 5 is a flow chart of an example method 500 for limiting the use of emotive ballistics. At 502, the media player 108 may display media content to a user. The ballistics module 222, at 504, detects an input selecting an emotive ballistic. At 506, the rule module 228 may determine whether a limit has been reached for use of the selected emotive ballistic. In various embodiments, the limit may be a global limit for the user, a limit per view of the media content, etc. If the rule module 228 determines, that the limit has not been reached, the ballistics module 222 displays, at 508, the emotive ballistic over the media content. In one embodiment, the rule module 228 may display, at 510, the number of remaining emotive ballistics. If, at 506, the rule module 228 determines that the limit has been reached, the rule module 228 may display an indication that the limit has been reached. The rule module 228 may further indicate when additional emotive ballistics will be available to the user.

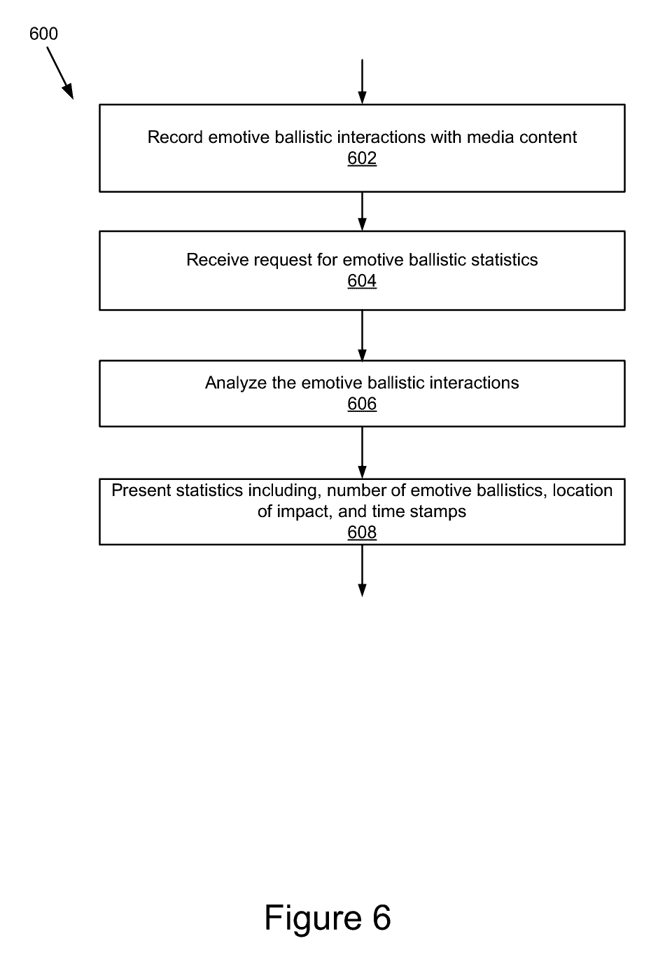

FIG. 6 is a flow chart of an example method 600 for logging emotive ballistics use and providing analytics based on the logged results. At 602, the analytics module 230 records emotive ballistic interactions with a media content time. For example, the analytics module 230 may track when during a video a user launches an emotive ballistic, where the emotive ballistic lands on the media content, etc. The analytics module 230 may aggregate the emotive ballistic interactions for a media content item from multiple users. At 604, the analytics module 230 receives a request from a content provider for statistics/analytics. For example, the request may be for collective emotive ballistics statistics over a number of media content items, for statistics for a single media content item over time (or for a particular period of time). At 606, the analytics module 230 analyzed the recorded emotive ballistics interactions. At 608, the analytics module 230 presents the statistics to the content provider.

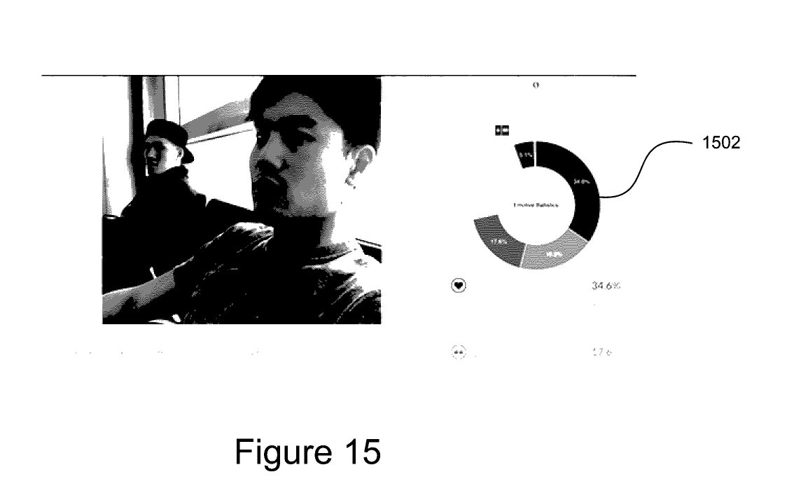

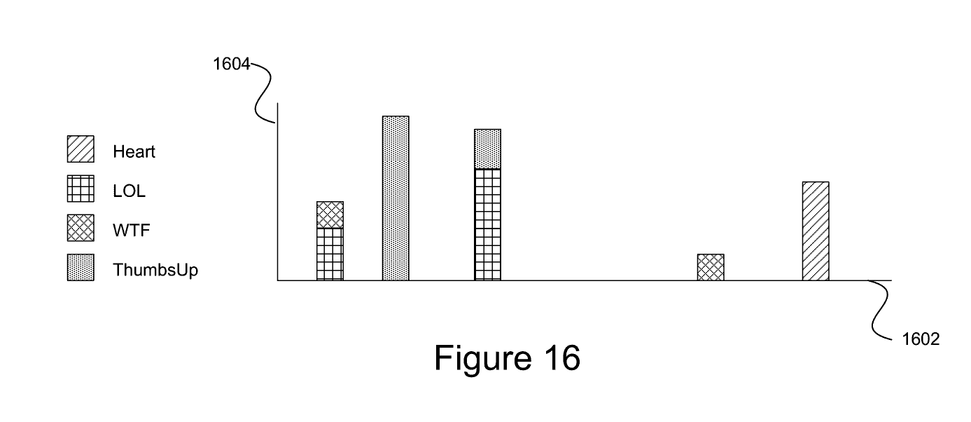

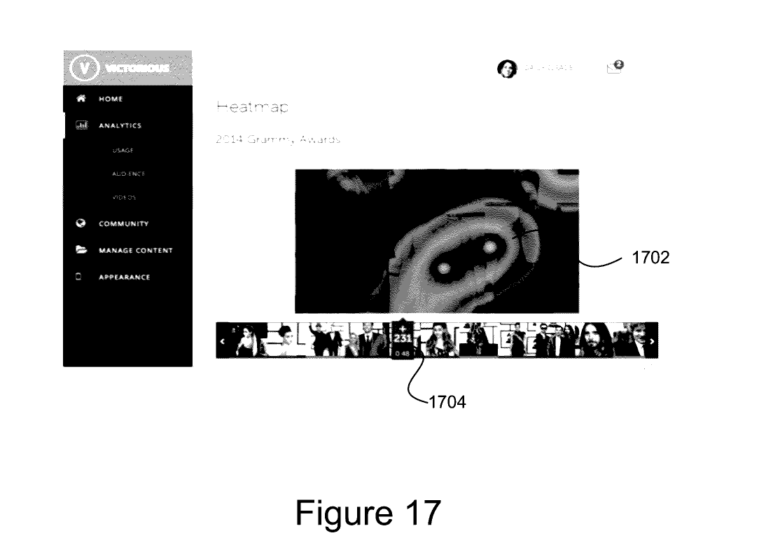

FIG. 15 is a graphic representation of an example interface for displaying emotive ballistics analytics. In the example of FIG. 15, the percentage of total emotive ballistics represented by various ballistics are presented to the user in a wheel chart 1502. It should be understood that other methods of presenting the statistics are considered. FIG. 16 is a graphic representation of an example bar chart showing emotive ballistic use for a media content over time. In the example of FIG. 16, the number of emotive ballistics are shown on axis 1604 and the media presentation time is shown on axis 1602. FIG. 17 is a graphic representation of an example heat map showing emotive ballistic location on media content at a particular time. The heat map in the example of FIG. 17 depicts the location 1702 of emotive ballistics at a particular time in a media content display. The timeline of the media content may display the number of emotive ballistics 1704 shown in the heat map.

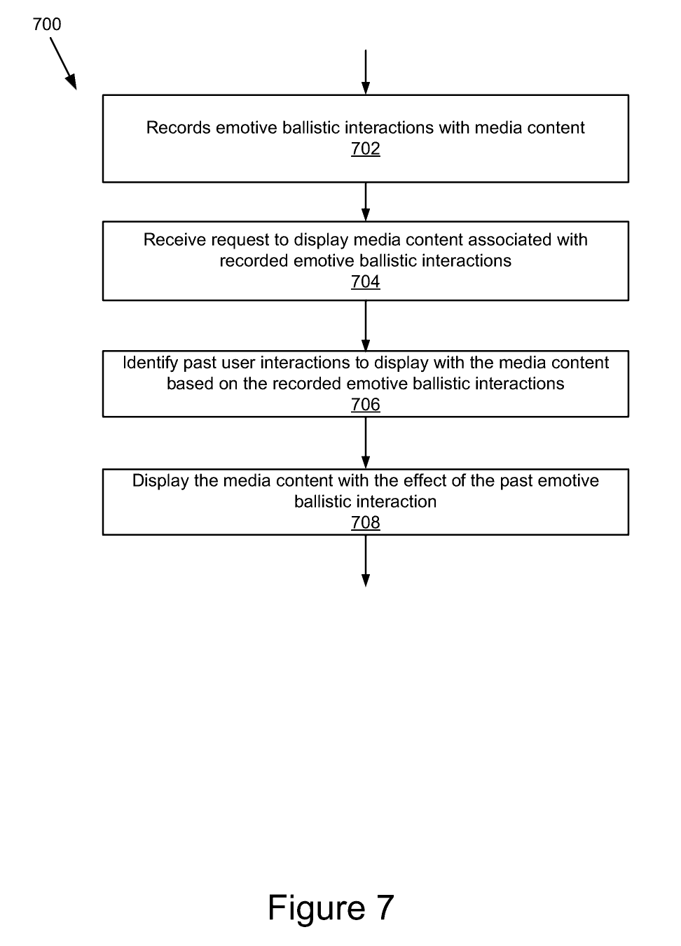

FIG. 7 is a flow chart of an example method 700 for modifying future display of media content based on a log of past user interactions with the media content. In various embodiments, the ballistics module 222 may display an impact of emotive ballistics in future presentations of the media content. For example, an emotive ballistic of a hammer hitting a portion of the media content may make that portion of the media content vibrate. In future presentations of the media content the ballistics module 222 may make that portion of the media content vibrate. At 702, the analytics module 230 records emotive ballistic interactions with the media content as described above with reference to FIG. 6. At 704, the media player 108 receives a request to display media content associated with recorded emotive ballistic interactions. At 706, the ballistics module 222 identifies past emotive ballistic interactions to display with the media content based on the recorded emotive ballistic interactions. In some embodiments, only particular emotive ballistics have a perpetual effect on media content. At 708, the ballistics module 222 display the media with the past emotive ballistic interaction.

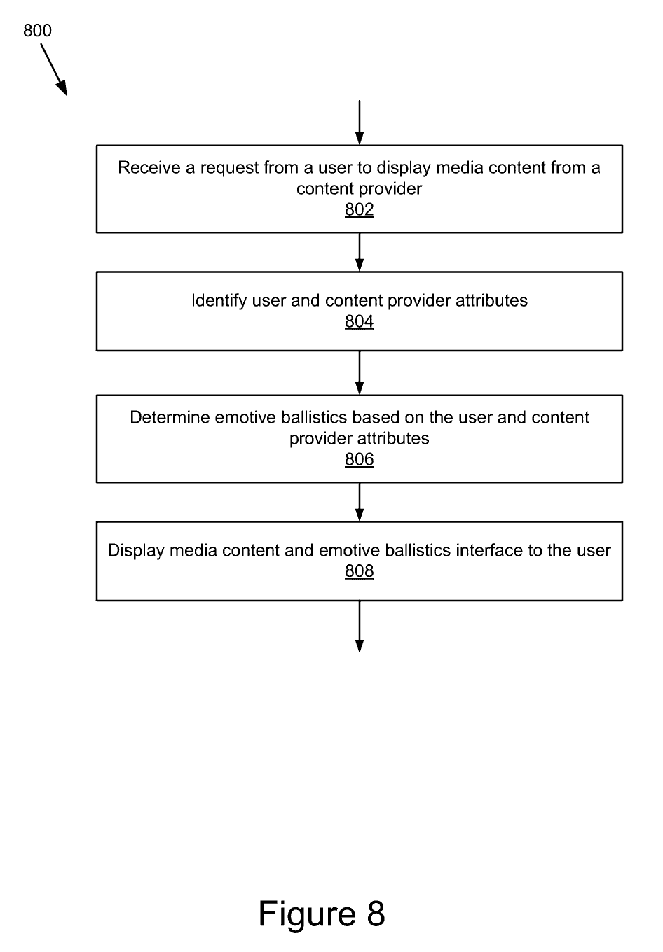

FIG. 8 is a flow chart of an example method 800 for determining emotive ballistics settings based on user and content provider attributes. At 802, the media player 108 receives a request to display media content form a content provider. At 804, the ballistics module 222 identifies user and content provider attributes. For example, the user and content provider attributes may include a location, language, etc. The location may be determined based on a user/content provider profile or may be determined based on device identification information (e.g., ESN, IP address, GPS location information, etc.). At 806, the ballistics module 222 determines emotive ballistics based on the user and content provider attributes. For example, a particular emotive ballistic may not make cultural sense to display to a user located in a particular region (e.g., throwing a tomato at the media content) and a suitable replacement would be substituted by the ballistics module. The ballistics module 222, at 808, may display the emotive ballistics interface in conjunction with the media player 108 displaying the media content.

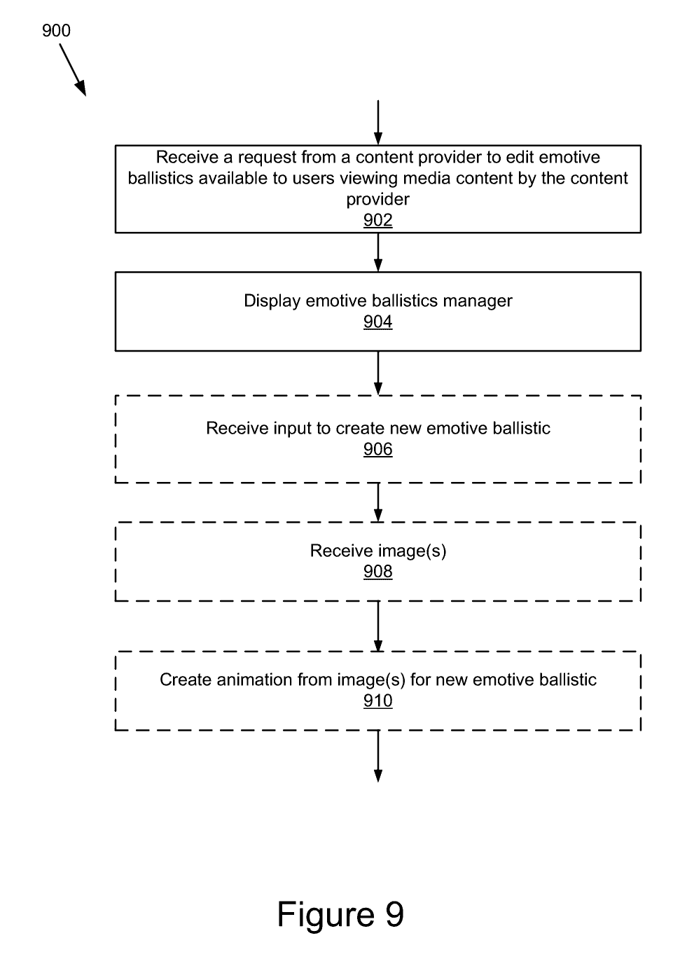

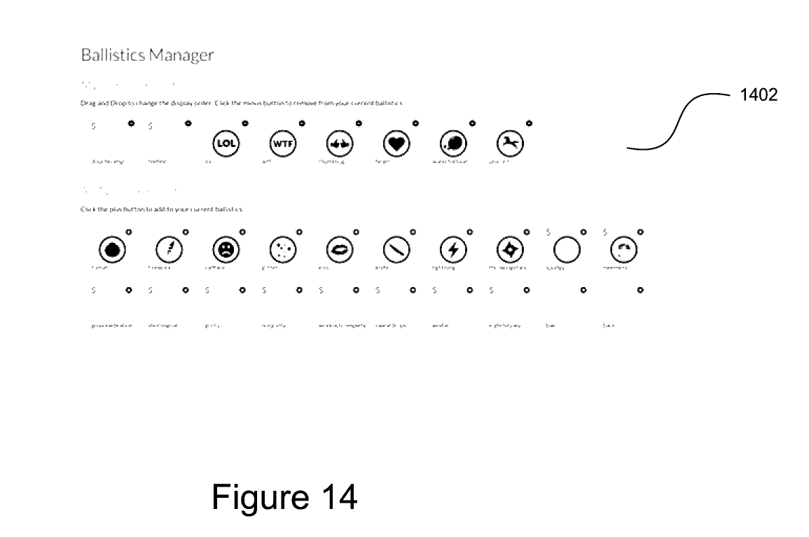

FIG. 9 is a flow chart of an example method 900 for emotive ballistics management by a content provider. At 902 the ballistics module 222 receives a request from a content provider to edit emotive ballistics available to users viewing media content by the content provider. At 904, the ballistics module 222 displays an emotive ballistics manager. FIG. 14 is a graphic representation of an example interface 1402 for managing emotive ballistics available for users while viewing media content. For example, the interface may provide options for the user to add/remove ballistics that are displayed to the user. In one embodiment, the user may create new emotive ballistics. At 906, the ballistics module 222 receives an input to create a new emotive ballistic. The ballistics module may present an interface for the user to upload or draw one or more images from which to create the new emotive ballistic. At 908, the ballistics module 222 receives the image(s) and at 910 creates an animation for the new emotive ballistic from the images. In some embodiments, the new emotive ballistic is available to only users who access the content provider's content. In other embodiments, the content provider may make the new emotive ballistic globally available to other content providers and share in revenue generated by purchase of the emotive ballistic.

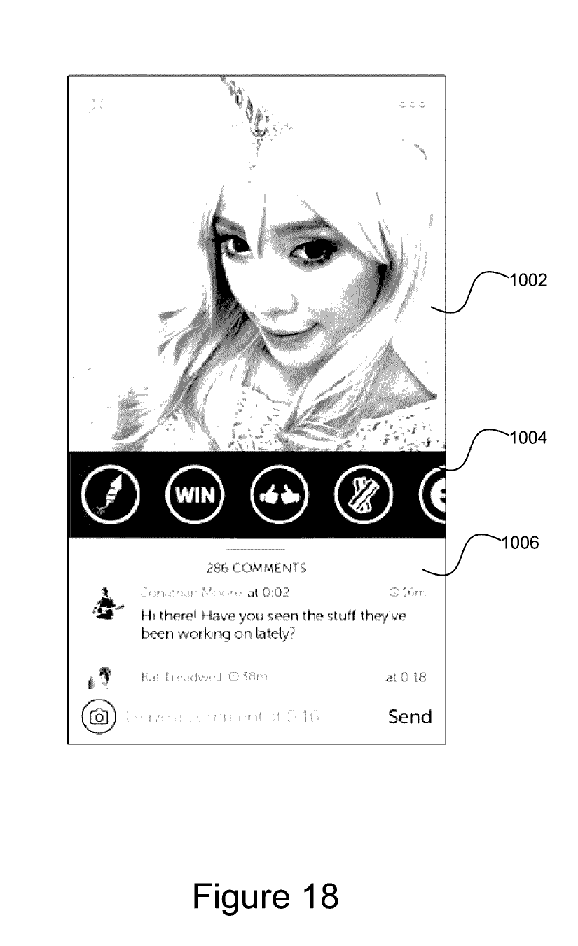

FIG. 18 is a graphic representation of an example media player application including a user interface for emotive ballistics according to another implementation. In this implementation, the user interface includes a window 1002 for presenting media content, an icon bar 1004 for displaying one or more selectable icons representing or corresponding to animated tags or emotive ballistics and a comments area 106. This interface provide an example of a user interface that provides free and unlimited use of the emotive ballistics in the icon bar 1004. While this interface provides free and unlimited use, it should be understood that the emotive ballistics application 104 in other implementations could specify the number of times and icon could be selected in a particular time period, when the icon could be selected, with what media content the icon could be selected, etc. Moreover, it should be understood that there are a variety of different emotive ballistics (e.g., hundreds), and the creator of the content may specify which emotive ballistics can be used, the user of the application may specify which emotive ballistics can be used, or an administrator or other party may specify which emotive ballistics can be used, and therefore which emotive ballistics are presented in the icon bar 1004.

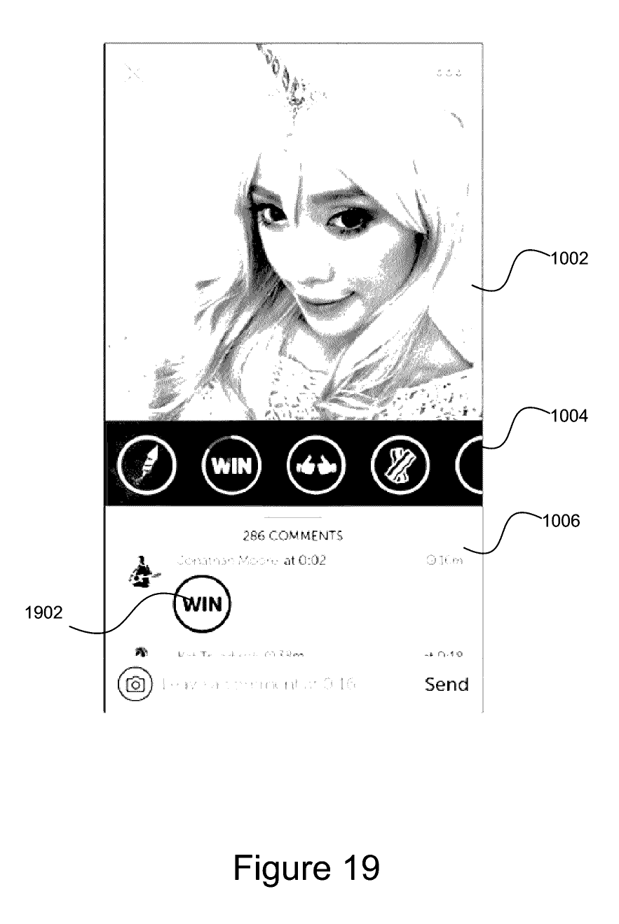

FIG. 19 is a graphic representation of an example media player application including a user interface showing a sent or thrown emotive ballistic. As can be seen in FIG. 19, in the comments section 1006, a particular user name and time along with a marker 1902 are shown to indicate that type of emotive ballistic was sent or thrown. In this example, the marker 1902 has a similar appearance to the icon selected to send the corresponding emotive ballistic. Additionally, since there is no comment and only the marker 1902, additional metadata about the location or time of the media content when the emotive ballistic was sent can be provided in the comments section. It should be understood that the marker 1902 can be presented in a variety of visually distinct formats to increase or decrease attention to use of the emotive ballistic. For example, here the marker 1902 is shown with a distinct color to so that it is clearly distinguishable from the selectable icons corresponding to emotive ballistics in the icon bar 1004.

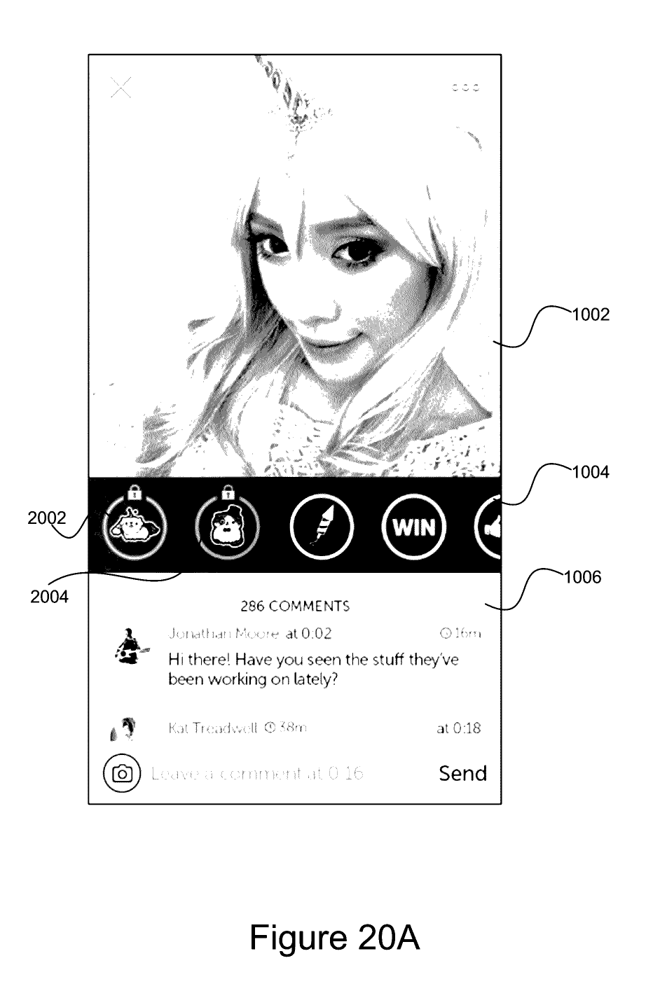

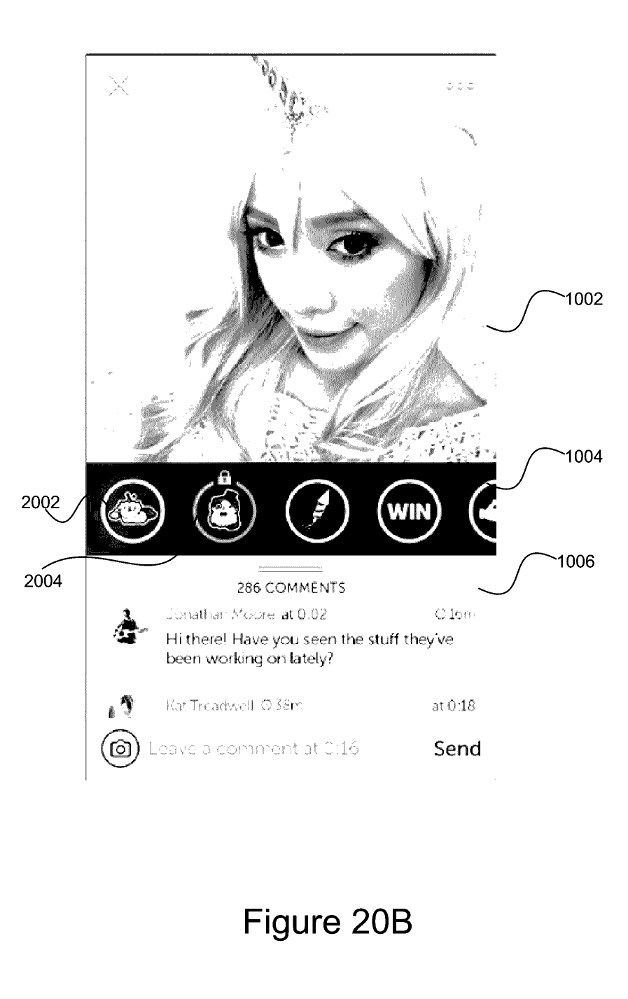

While FIG. 19 showed freely usable emotive ballistics, FIGS. 20A-20B show a user interface for an example media player application that includes both locked and unlocked emotive ballistics. More specifically as shown in FIG. 20A, the icon bar 104 includes two example emotive ballistics 2002, 2004 that are locked and not selectable by the user. The other emotive ballistic icons are freely usable as described above with reference to FIG. 19. It should be understood that the locked emotive ballistics 2002, 2004 may be presented in a variety of visually distinct formats so that they may be distinguished from other unlocked or selectable emotive ballistics in the icon bar 104. In this specific example, the locked emotive ballistics 2002, 2004 have a lock symbol added near their top. Additionally, the border of the locked emotive ballistics 2002, 2004 is partially opaque so they appear different from the unlocked or selectable emotive ballistics. However, this is merely one example for distinguishing emotive ballistics 2002, 2004 as locked and various other visually distinct formats may be employed. Depending on the circumstances, the locked emotive ballistics 2002, 2004 will remain in that state until some action is taken by the user. For example, access to the locked emotive ballistics 2002, 2004 may be provided if the user make and in application purchase to unlock the locked emotive ballistics 2002, 2004. Access to the locked emotive ballistics 2002, 2004 may also be provided after the has taken other actions including but not limited to viewing a number of videos, providing comments or reviews, interacting in other ways with the media content, using other emotive ballistics a predetermined number of times, or any other action, the creator of the content or the administrator of the application may require. Referring now also to FIG. 20B, show the user interface updated after the user has unlocked the first emotive ballistic 2002. As shown in FIG. 20B, the first emotive ballistic 2002 no longer includes a lock symbol and its border is changed from opaque to white.

The use of user interfaces described above with reference to FIGS. 20A and 20B are particularly advantageous for consumable daily emotive reactions. The emotive ballistics application 104 provides functionality for a feature referred to as consumable daily emotive reactions. The objective of consumable daily emotive reactions is to test the monetization potential of reactions via in-app purchases. A more robust monetization feature is to test micro-transactions on reactions via a currency system. This feature is advantageous because it is easier to build and user data and analytics can be generated faster. This consumable daily emotive reactions feature increases payer metrics (% paying, ARPPU) to be comparable to other successful mobile apps. Additionally, this feature increases in sessions per day (with an energy system) and an increase in daily return rate (with daily reactions), as users return to emotive ballistics application 104 more frequently to make use of reactions that become available for use. In one basic example, a user starts with 10 Reaction Units, e.g., the ability to send or throw 10 emotive ballistics. When a user gives any individual Reaction to a piece of content (e.g., LOL, Unicorn, Bae, etc.), a Reaction Unit is consumed. So 10 Reaction Units would be reduced to 9 Reaction Units, and so on. When the number of Reaction Units goes down to 0, the user can no longer give a Reaction to a piece of content. Individual Reaction Units do NOT recharge over time. The number of available Reaction Units resets to 10 the next day, no matter how many were consumed the previous day. If a user consumes 10 Reaction Units today, he/she will have 10 Reaction Units available tomorrow. If a user consumers 0 Reaction Units today, he/she will also have 10 Reaction Units available tomorrow. Users cannot “save” daily Reaction Units and accumulate them over time. Once the number of Reaction Units goes down to 0, the user can pay for more Reactions (e.g., 10, 25, or 60). Purchases can cause the total number of available Reaction Units to exceed 10. In this case, the number of Reaction Units no longer resets to 10 each day, until the user consumes enough Reaction Points to cause the number of available Reaction Units to go below 10.

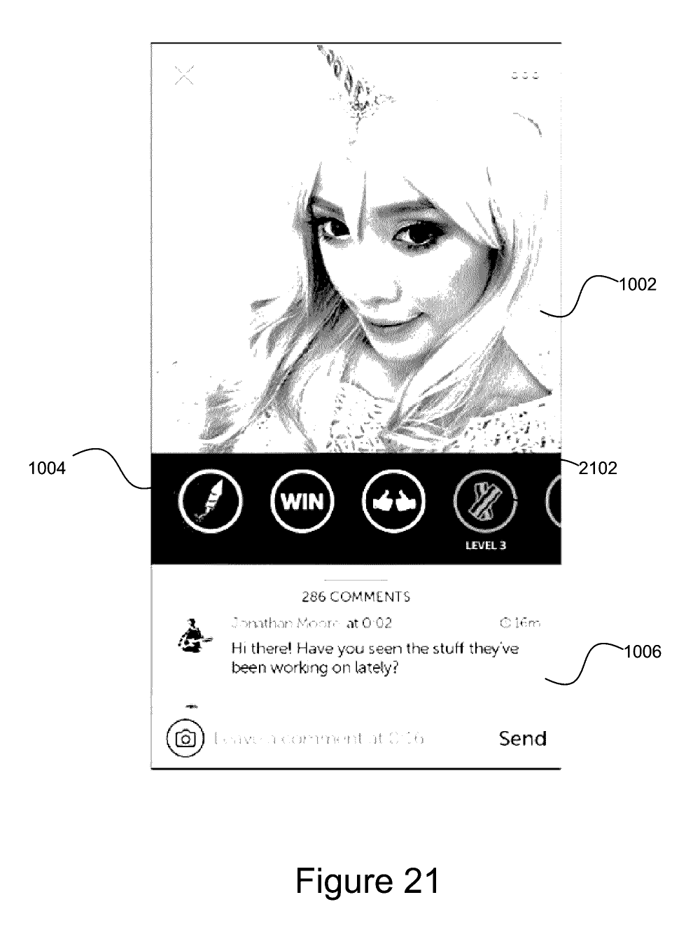

Referring now to FIG. 21, another example of a locked emotive ballistic 2102 is shown. In this example, the locked emotive ballistic 2102 is shown in a partially opaque format but with no lock symbol. The absence of a lock symbol is use to indicate that locked emotive ballistic 2102 must be earned by reaching level 3 and cannot be use by doing an in application purchase. Providing such a locked emotive ballistic 2102 presents the incentive or reward in the icon bar 1004 for reaching a particular level. While leveling up in use as an example action for unlocking the locked emotive ballistic 2102, it should be understood that in other implementations, the creator could specify various other action, groups or set of action, etc. that may be required to unlock the locked emotive ballistic 2102. It should be understood that the icons and visual formatting are merely example and other formatting may be used to signify a locked emotive ballistic.

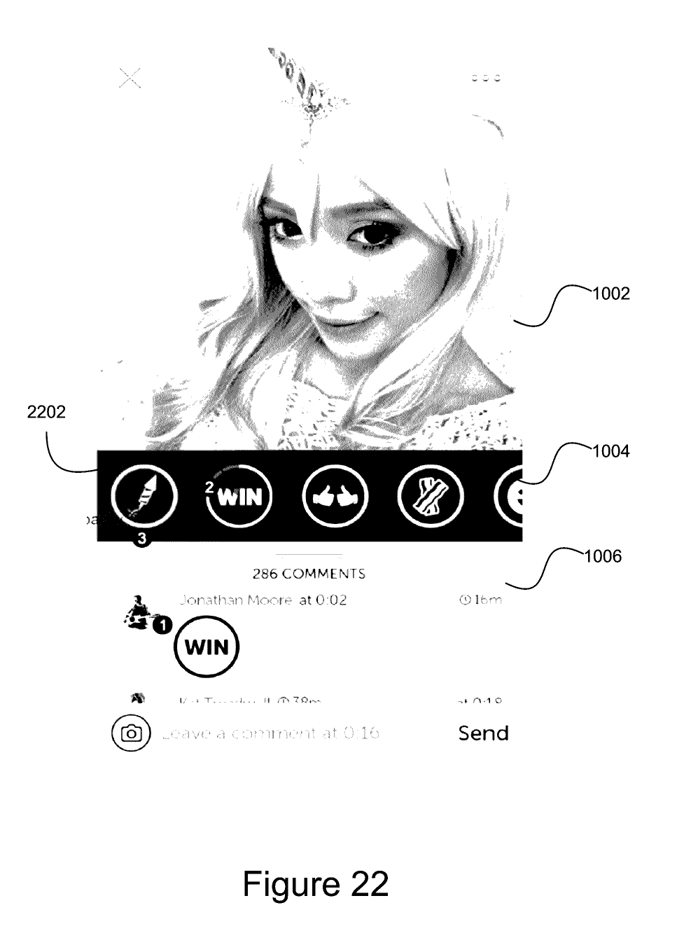

FIG. 22 is a graphic representation of an example media player application including a user interface showing an emotive ballistic 2202 with a countdown timer before the emotive ballistics is selectable. FIG. 22 illustrate the ability of the emotive ballistics application 104 to assign “cool down timers” to individual emotive ballistics. If a user clicks/taps or otherwise selects the emotive ballistic 2202 and throws it at the window 1002, a timer disables the emotive ballistic 2202 and prevents the emotive ballistic 2202 from being selected or thrown at the screen 1002 for a defined period of time. This advantageously prevents user from sending multiple emotive ballistics at a high rate. The rate and rules around the rate can be varied according to the content creator's specifications. In one example, the user is allowed two selections (taps) of the same emotive ballistic followed by a 15 second countdown timer. As shown in FIG. 22, the countdown timer may be depicted as opacity of the icon representing the emotive ballistic. Once icon is selected/thrown, the icon change to a reduced percentage of opacity (e.g., 50% opacity). An additional animation is then added to the reduced opacity icon by showing the icon representing the emotive ballistic is shown with a clockwise animation that returns the icon to 100% opacity. More specifically as shown in FIG. 22, the animation has reached a point in the rotation where more than three quarter of the rotation has occurred so less than one quarter of the emotive ballistic 2202 is shown with reduced opacity. It should be understood that opacity and a clockwise animation are merely example, and various other type of highlighting and animation may be used, such as shading, color, cross hatching with other animations that progress from top to bottom, left to right, counter clockwise, inward, outward, etc.

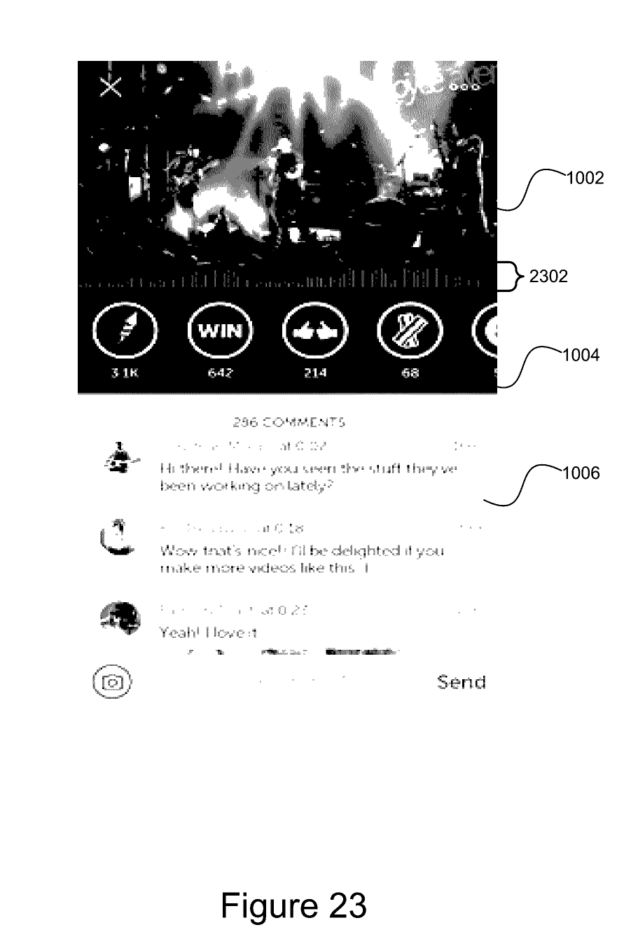

FIG. 23 is a graphic representation of an example media player application including one implementation of the user interface that includes a display of when and how many emotive ballistics are being sent by others. The user interface of FIG. 23 illustrates how the emotive ballistics application 104 displays information about the emotive ballistics being sent or “thrown” by others in the user interface. FIG. 19 described above provide more particular information about which person sent the emotive ballistic, for which content and at what time as well as a time in the media content. As shown in FIG. 23, and additional area 2304 is provided to present to the user information about the emotive ballistics being sent or “thrown” by others. In this example, the additional area 2304 is positioned below the window 1002 and above the icon bar 1004. However, in other implementations, the additional area 2304 could be a side bar, drawer that is selectable exposed, or at different positions in the user interface. In the example of FIG. 23, the information about the emotive ballistics being sent or “thrown” by others on the network is shown in the form of a histogram of emotive ballistics that are being thrown and at what time. The emotive ballistics application 104 also update the window 1002 to show animations of emotive ballistics in real time as other users throw onto a piece of content. A list of EB that have been thrown by which person have been described above with reference to FIG. 19.

Systems and methods enabling and tracking user interactions with media content. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above primarily in the context of on line services; however, the disclosed technologies apply to other data sources and other data types (e.g., collections of other resources for example images, audio, web pages).

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A computer-implemented method comprising:
providing a user interface for selecting an animated tag to add to media content, the user interface presenting the media content;
receiving a selection of the animated tag and an attribute of the media content;
responsive to receiving the selection of the animated tag and the attribute of the media content, adding the animated tag to media content based upon the attribute; and
providing the media content with the added animated tag for display.

2. The computer-implemented method of claim 1, wherein the user interface includes a plurality of icons each icon corresponding to a different animated tag.

3. The computer-implemented method of claim 1, wherein:
the media content is video;
the attribute of the media content is a temporal range within the video; and
the animated tag is added to the video within the temporal range.

4. The computer-implemented method of claim 1, wherein:
the media content is an image;
the attribute of the media content is a location in the image; and
the animated tag is added to the image to appear near the location in the image;

5. The computer-implemented method of claim 1, wherein the selection is a swipe gesture beginning at an icon in the user interface, the icon representing the animated tag, the swipe gesture toward the media content, and wherein the icon is further animated to appear as being thrown from an icon bar including the icon onto a window displaying the media content.

6. The computer-implemented method of claim 1, wherein the animated tag is represented in the user interface with a locked icon and is not selectable until an action unlocks the animated tag making it usable.

7. The computer-implemented method of claim 1, further comprising disabling selection of the animated tag in the user interface for a predetermined amount of time.

8. A system comprising:
a processor; and
a memory storing instructions that, when executed, cause the system to perform operations comprising:
providing a user interface for selecting an animated tag to add to media content, the user interface presenting the media content;
receiving a selection of the animated tag and an attribute of the media content;
responsive to receiving the selection of the animated tag and the attribute of the media content, adding the animated tag to media content based upon the attribute; and
providing the media content with the added animated tag for display.

9. The system of claim 8, wherein the user interface includes a plurality of icons each icon corresponding to a different animated tag.

10. The system of claim 8, wherein:
the media content is video;
the attribute of the media content is a temporal range within the video; and
the animated tag is added to the video within the temporal range.

11. The system of claim 8, wherein
the media content is an image;
the attribute of the media content is a location in the image; and
the animated tag is added to the image to appear near the location in the image;

12. The system of claim 8, wherein the selection is a swipe gesture beginning at an icon in the user interface, the icon representing the animated tag, the swipe gesture toward the media content, and wherein the icon is further animated to appear as being thrown from an icon bar including the icon onto a window displaying the media content.

13. The system of claim 8, wherein the animated tag is represented in the user interface with a locked icon and is not selectable until an action unlocks the animated tag making it usable.

14. The system of claim 8, wherein the operations further comprise disabling selection of the animated tag in the user interface for a predetermined amount of time.

15. A computer program product comprising a non-transitory computer readable medium including a computer readable program, wherein the computer readable program when executed on a computer causes the computer to perform operations comprising:
providing a user interface for selecting an animated tag to add to media content, the user interface presenting the media content;
receiving a selection of the animated tag and an attribute of the media content;
responsive to receiving the selection of the animated tag and the attribute of the media content, adding the animated tag to media content based upon the attribute; and
providing the media content with the added animated tag for display.

16. The computer program product of claim 15, wherein
the media content is video;
the attribute of the media content is a temporal range within the video; and
the animated tag is added to the video within the temporal range.

17. The computer program product of claim 15, wherein
the media content is an image;
the attribute of the media content is a location in the image; and
the animated tag is added to the image to appear near the location in the image;

18. The computer program product of claim 15, wherein the selection is a swipe gesture beginning at an icon in the user interface, the icon representing the animated tag, the swipe gesture toward the media content, and wherein the icon is further animated to appear as being thrown from an icon bar including the icon onto a window displaying the media content.

19. The computer program product of claim 15, wherein the animated tag is represented in the user interface with a locked icon and is not selectable until an action unlocks the animated tag making it usable.

20. The computer program product of claim 15, wherein the operations further comprise disabling selection of the animated tag in the user interface for a predetermined amount of time.
